(19) United States
(12) Patent Application Publication
(10) Pub. No.: US 2019/0092160 A1
(43) Pub. Date: Mar. 28, 2019

(54) FUEL TANK STRUCTURE

(71) Applicant: TOYOTA JIDOSHA KABUSHIKI KAISHA, Toyota-shi (JP)

(72) Inventors: Shinsuke AMANO, Okazaki-shi (JP); Hideki IWATA, Nagoya-shi (JP)

(73) Assignee: TOYOTA JIDOSHA KABUSHIKI KAISHA, Toyota-shi (JP)

(21) Appl. No.: 16/122,397

(22) Filed: Sep. 5, 2018

(30) Foreign Application Priority Data
Sep. 25, 2017 (JP) 2017-183988

(51) Int. Cl. B60K 15/03

(52) U.S. Cl. CPC B60K 15/03177; B60K 15/067

(57) ABSTRACT

A fuel tank structure including: a fuel tank that is made of resin, and that is structured to include an upper wall portion and a lower wall portion; a supporting pillar portion that is made of resin, that is provided at an inner side of the fuel tank, that has one end portion welded to the upper wall portion and another end portion welded to the lower wall portion, and that connects the upper wall portion and the lower wall portion in a vehicle vertical direction; a sub-cup that is disposed at the inner side of the fuel tank; an urging portion that urges the sub-cup toward the lower wall portion; and a restricting portion that is provided at the supporting pillar portion, and that restricts relative displacement of the sub-cup with respect to the fuel tank in directions orthogonal to the vehicle vertical direction.

### CROSS-REFERENCE TO RELATED APPLICATION

This application is based on and claims priority under 35 USC 119 from Japanese Patent Application No. 2017-183988 filed on Sep. 25, 2017, the disclosure of which is incorporated by reference herein.

### BACKGROUND

### Technical Field

The present disclosure relates to a fuel tank structure.

### Related Art

An invention relating to a fuel tank structure is disclosed in Japanese Patent Application Laid-Open (JP-A) No. 2013-116673. In this fuel tank structure, a sub-cup is provided at the inner side of a fuel tank, and a predetermined amount of fuel can be stored at the inner side of this sub-cup. Therefore, even if the fuel tank tilts and there becomes a state in which the fuel that is stored at the inner side of the fuel tank is unevenly distributed, fuel can be stably supplied to a power unit, such as an engine or the like, by using the fuel that is stored in the sub-cup.

Further, in JP-A No. 2013-116673, the sub-cup is urged by a coil spring and is pushed against the lower wall portion of the fuel tank. Therefore, relative displacement between the sub-cup and the lower wall portion of the fuel tank is suppressed, and changes in the posture of the sub-cup can be suppressed.

However, in JP-A No. 2013-116673, relative displacement between a module cup and the lower wall portion of the fuel tank is suppressed only by the frictional force that operates therebetween. Thus, it is thought that the posture and/or the position of the module cup with respect to the fuel tank will change due to movement of the fuel at times of acceleration and deceleration of the vehicle and the like.

Namely, in the above-described related art, there is room for improvement with regard to the point of keeping the position and the posture of the sub-cup with respect to the fuel tank in stable states.

### SUMMARY

The present disclosure provides a fuel tank structure in which the position and the posture of a sub-cup with respect to a fuel tank can be maintained in stable states.

A fuel tank structure relating to a first aspect of the present disclosure includes: a fuel tank that is made of resin, that is structured to include an upper wall portion that structures a vehicle upper side portion and a lower wall portion that structures a vehicle lower side portion, and that stores fuel that is to be supplied to a power unit mounted in a vehicle; a supporting pillar portion that is made of resin, that is provided at an inner side of the fuel tank, that has one end portion welded to the upper wall portion and another end portion is welded to the lower wall portion, and that connects the upper wall portion and the lower wall portion in a vehicle vertical direction; a sub-cup that is disposed at the inner side of the fuel tank, and that stores some of the fuel; an urging portion that urges the sub-cup toward the lower wall portion; and a restricting portion that is provided at the supporting pillar portion, and that restricts relative displacement of the sub-cup with respect to the fuel tank in directions orthogonal to the vehicle vertical direction.

In accordance with the first aspect of the present disclosure, the fuel tank structure has the fuel tank that is made of resin and that can store fuel that is to be supplied to the power unit that is mounted in the vehicle. This fuel tank is structured to include an upper wall portion that structures the vehicle upper side portion thereof, and a lower wall portion that structures the vehicle lower side portion thereof. Further, the supporting pillar portion that is made of resin is provided at the inner side of the fuel tank. One end portion of the supporting pillar portion is welded to the upper wall portion of the fuel tank, and the other end portion of the supporting pillar portion is welded to the lower wall portion of the fuel tank. The upper wall portion and the lower wall portion are connected in the vehicle vertical direction by the supporting pillar portion. Therefore, in the present disclosure, relative displacement between the upper wall portion and the lower wall portion of the fuel tank is suppressed, and accordingly, the shape of the fuel tank can be maintained in a stable state.

Moreover, in the present disclosure, the sub-cup is disposed at the inner side of the fuel tank, and can store some of the fuel that is stored in the fuel tank. Therefore, even if the fuel tank tilts and there becomes a state in which the fuel that is stored at the inner side of the fuel tank is unevenly distributed, fuel can be stably supplied to the power unit by using the fuel stored in the sub-cup.

In addition, in the present disclosure, the fuel tank structure has the urging portion that urges the sub-cup toward the lower wall portion of the fuel tank. The sub-cup is urged by the urging portion, and is pushed against the lower wall portion. Therefore, relative displacement between the sub-cup and the lower wall portion of the fuel tank is suppressed, and changes in the posture of the sub-cup can be suppressed.

By the way, when the fuel within the fuel tank moves at the time of acceleration or deceleration of the vehicle or the like, the sub-cup receives force from the fuel that moves, and it is thought that the position and/or the posture of the sub-cup with respect to the fuel tank will change.

Here, in the present disclosure, the restricting portion is provided at the supporting pillar portion, and relative displacement, in directions orthogonal to the vehicle vertical direction, of the sub-cap with respect to the fuel tank can be restricted by the restricting portion. Therefore, at times of acceleration and deceleration of the vehicle or the like, even if the sub-cup is displaced relative to the fuel tank in a direction orthogonal to the vehicle vertical direction due to fuel within the fuel tank moving and the sub-cup receiving force from the fuel, this relative displacement is restricted by the restricting portion.

In a fuel tank structure relating to a second aspect of the present disclosure, in the first aspect, a first supporting pillar portion, which serves as the supporting pillar portion and at which a first restricting portion that serves as the restricting portion is provided, and a second supporting pillar portion, which serves as the supporting pillar portion and at which a second restricting portion that serves as the restricting portion is provided, are provided at the fuel tank, and the first supporting pillar portion and the second supporting pillar portion are disposed at positions such that the sub-cup is interposed therebetween as viewed from the vehicle vertical direction.

In accordance with the second aspect of the present disclosure, the fuel tank structure is provided with the first supporting pillar portion at which the first restricting portion is provided, and the second supporting pillar portion at which the second restricting portion is provided. The first supporting pillar portion and the second supporting pillar portion are disposed at positions that are such that the sub-cup is interposed therebetween, as viewed from the vehicle vertical direction. Therefore, in the present disclosure, relative displacement of the sub-cup with respect to the fuel tank in directions orthogonal to the vehicle vertical direction can be restricted from two directions as viewed from the vehicle vertical direction.

In a fuel tank structure relating to a third aspect of the present disclosure, in the first or second aspect, the restricting portion is structured by a body that is separate from the supporting pillar portion, and the restricting portion is structured to include an abutting portion, which restricts the relative displacement by abutting the sub-cup, and a supporting portion, which supports the abutting portion and can be mounted to the supporting pillar portion.

In accordance with the third aspect of the present disclosure, the restricting portion is structured by a body that is separate from the supporting pillar portion of the fuel tank, and the restricting portion is structured to include the abutting portion and the supporting portion. Due to the abutting portion abutting the sub-cup, relative displacement of the sub-cup with respect to the fuel tank in directions orthogonal to the vehicle vertical direction is restricted. On the other hand, the supporting portion supports the abutting portion, and can be mounted to the supporting pillar portion. Therefore, as compared with a structure in which the restricting portion is provided integrally with the supporting pillar portion, in the present disclosure, the position of the portion, which restricts displacement of the sub-cup, at the restricting portion can be set easily.

By the way, in a case in which the restricting portion and the supporting pillar portion are made integral and are structured by a single member, if the positional relationship between the supporting pillar portion and the sub-cup is to be changed due to a change in the shape of the fuel tank corresponding to the type of vehicle, or the like, the shapes of these members must be changed as well in order to correspond to that positional relationship. Namely, in a structure in which the restricting portion and the supporting pillar portion are made to be an integral member, common usage of these members at fuel tanks of different shapes cannot be devised.

On the other hand, in the present disclosure, even if the positional relationship between the supporting pillar portion and the sub-cup is to be changed due to a change in the shape of the fuel tank that corresponds to the type of the vehicle, or the like, correspondence with that positional relationship can be achieved by changing the shape of either one of the supporting pillar portion and the restricting portion, and the shape of the other of the supporting pillar portion and the restricting portion can be maintained.

In a fuel tank structure relating to a fourth aspect of the present disclosure, in the third aspect that is in the second aspect, the first restricting portion has a pair of first abutting piece portions that serve as the abutting portion, and the second restricting portions have a pair of second abutting piece portions that serve as the abutting portion.

In accordance with the fourth aspect of the present disclosure, the first restricting portion has the pair of first abutting piece portions, and the second restricting portion has the pair of second abutting piece portions. Therefore, in the present disclosure, relative displacement of the sub-cup with respect to the fuel tank in directions orthogonal to the vehicle vertical direction can be supported at two places of the first restricting portion, and can be supported at two places of the second restricting portion.

In a fuel tank structure relating to a fifth aspect of the present disclosure, in the third or fourth aspect, a fuel gauge can be mounted to the supporting portion.

In accordance with the fifth aspect of the present disclosure, a fuel gauge can be mounted to the supporting portion that structures a portion of the restricting portion. As compared with a case in which a member for mounting the fuel gauge is provided separately, the number of parts that are disposed within the fuel tank can be reduced.

As described above, the fuel tank structure relating to the first aspect of the present disclosure has the excellent effect that the position and the posture of the sub-cup with respect to the fuel tank can be maintained in stable states.

The fuel tank structure relating to the second aspect of the present disclosure has the excellent effect that the accuracy of restricting relative displacement of the sub-cup with respect to the fuel tank in directions orthogonal to the vehicle vertical direction can be improved.

The fuel tank structure relating to the third aspect of the present disclosure has the excellent effect that the supporting pillar portion or the restricting portion can be used in common at fuel tanks of different shapes, while positioning of the restricting portion and the sub-cup is made to be simple.

The fuel tank structure relating to the fourth aspect of the present disclosure has the excellent effect that relative displacement of the sub-cup with respect to the fuel tank in directions orthogonal to the vehicle vertical direction can be restricted in a stable state.

The fuel tank structure relating to the fifth aspect of the present disclosure has the excellent effect that the structure of the interior of the fuel tank can be simplified, while the volume of the fuel tank is ensured.

### BRIEF DESCRIPTION OF THE DRAWINGS

Exemplary embodiments of the present disclosure will be described in detail based on the following figures, wherein:

FIG. 1 is an enlarged plan view showing the structure surrounding main portions of a fuel tank relating to a first embodiment (a view seen in the direction of arrow 1 in FIG. 3);

FIG. 2 is an exploded perspective view showing the structure of main portions of the fuel tank relating to the first embodiment;

FIG. 3 is an enlarged sectional view showing the structure surrounding a sub-cup in the fuel tank relating to the first embodiment (a cross-sectional view showing the state cut along line 3-3 of FIG. 1);

FIG. 4 is an enlarged sectional view showing the structure surrounding a supporting pillar portion of the fuel tank relating to the first embodiment (a cross-sectional view showing the state cut along line 4-4 of FIG. 1);

FIG. 5 is a cross-sectional view that is seen from the vehicle rear side and shows the structure of the fuel tank relating to the first embodiment; and

FIG. 6 is a perspective view showing the structure of main portions of a fuel tank relating to a second embodiment.

### DETAILED DESCRIPTION

### First Embodiment

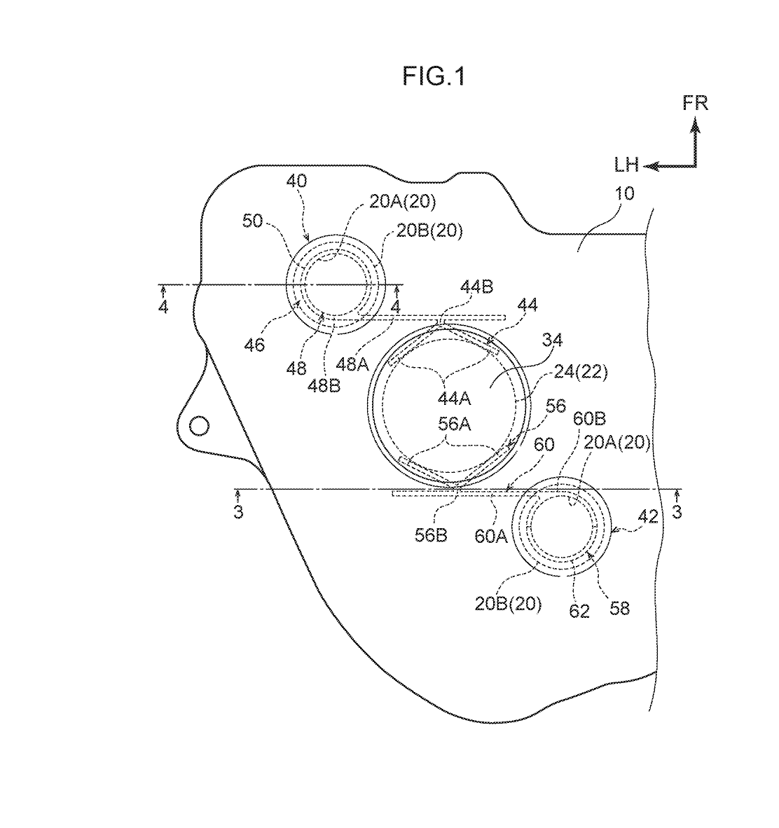

A first embodiment of a fuel tank structure relating to the present disclosure is described hereinafter by using FIG. 1 through FIG. 5. Note that arrow FR that is shown appropriately in the respective drawings indicates the vehicle front side, arrow UP indicates the vehicle upper side, and arrow LH indicates the vehicle transverse direction left side.

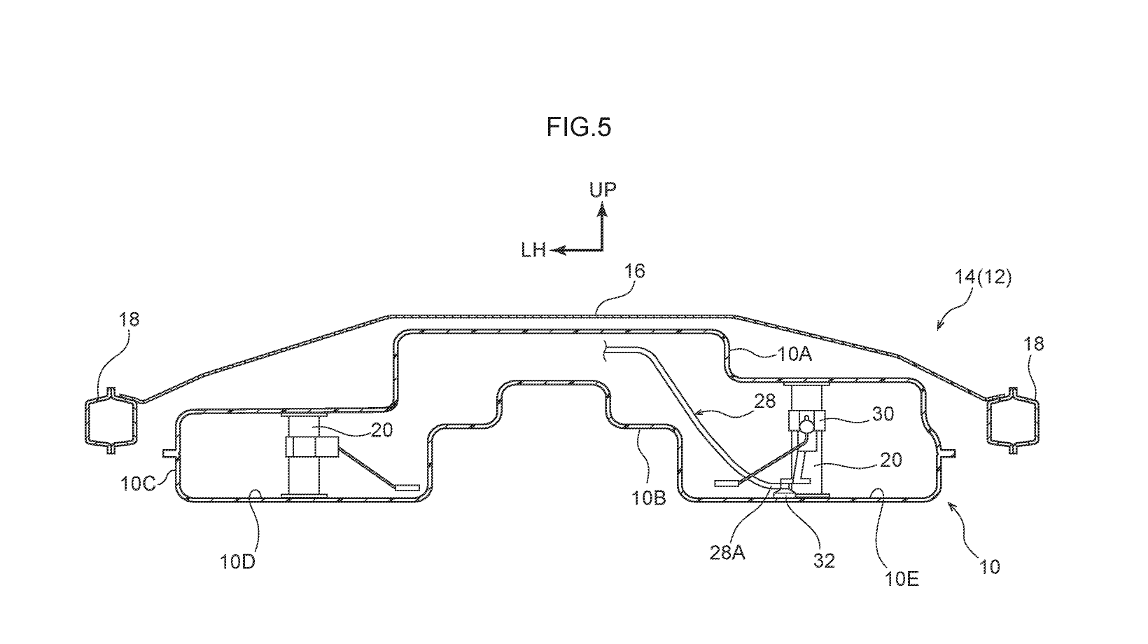

First, the structure of a vehicle body 14 of a “vehicle 12”, in which is mounted a “fuel tank 10” to which the fuel tank structure relating to the present embodiment is applied, is described by using FIG. 5. Note that, in the present embodiment, because the vehicle body 14 and the fuel tank 10 are structures that basically have left-right symmetry, in the following description, the structures of the vehicle transverse direction left side portions of the vehicle body 14 and the fuel tank 10 are mainly described, and description of the structures of the vehicle transverse direction right side portions thereof is omitted as appropriate.

The vehicle body 14 has a floor panel 16 that structures a portion of the floor portion of the vehicle body 14. This floor panel 16 is formed by press working a steel plate, and extends in the vehicle longitudinal direction and the vehicle transverse direction as seen as viewed from the vehicle vertical direction.

A pair of left and right rear side members 18 that are made of steel are disposed at the vehicle lower side of the floor panel 16, along the peripheral edge portions that are at the vehicle transverse direction outer sides of the floor panel 16. The rear side members 18 are closed cross-sectional structures whose cross-sections, as viewed from the vehicle longitudinal direction, are substantially rectangular, and are joined to the floor panel 16 at unillustrated joined portions that are formed by welding or the like.

On the other hand, the fuel tank 10 is disposed at the vehicle lower side of the floor panel 16, and more concretely, as viewed from the vehicle vertical direction, the fuel tank 10 is disposed at a position that overlaps an unillustrated rear seat, and the main portion of the fuel tank 10 is accommodated between the rear side members 18.

The fuel tank 10 is structured, of a high-density polyethylene resin, so as to include an “upper wall portion 10A” that structures the vehicle upper side portion thereof, a “lower wall portion 10B” that structures the vehicle lower side portion thereof, and a peripheral wall portion 10C that structures the outer peripheral portion thereof and connects the upper wall portion 10A and the lower wall portion 10B.

As shown in FIG. 1, the upper wall portion 10A and the lower wall portion 10B respectively are shaped as plates that are substantially trapezoidal and whose widths decrease toward the vehicle rear side as viewed from the vehicle vertical direction. The vehicle transverse direction central portions of the upper wall portion 10A and the lower wall portion 10B bulge-out toward the vehicle upper side. Namely, the fuel tank 10 is formed to be a so-called saddle type that has, at the vehicle lower side portion of the vehicle transverse direction central portion thereof, a concave portion for the placement of a propeller shaft and the like.

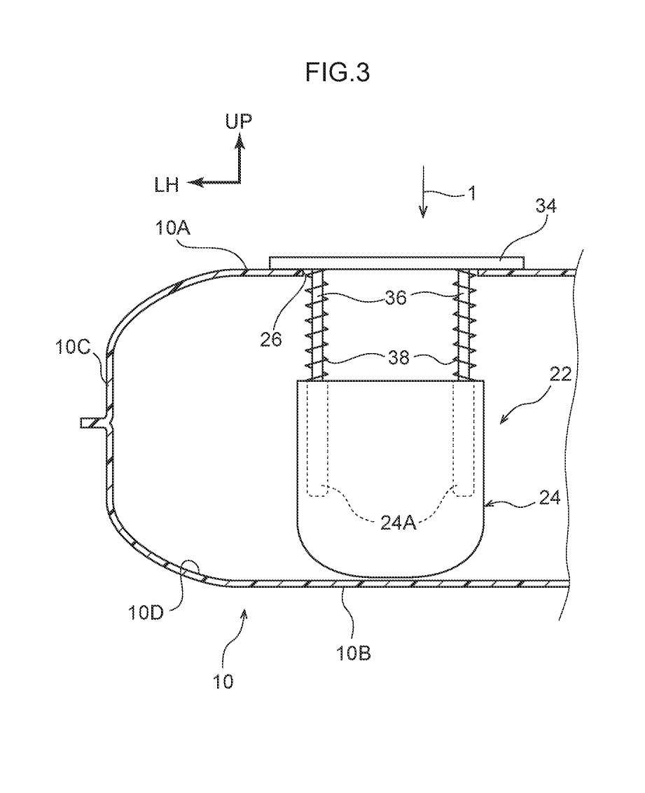

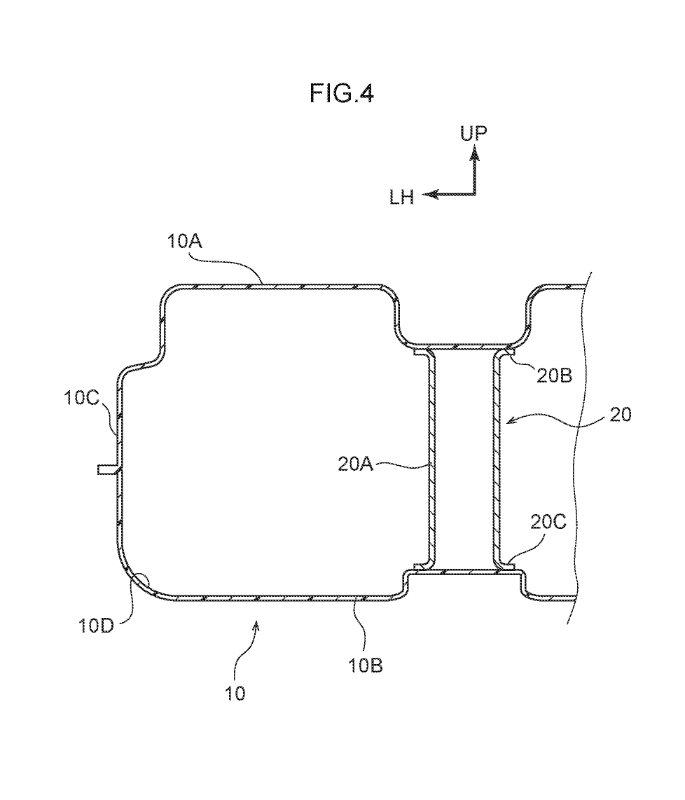

A closed space is formed at the inner side of the fuel tank 10 that is structured as described above. Fuel, such as gasoline or the like that is to be supplied to an unillustrated power unit such as an engine or the like that is mounted in the vehicle 12, can be stored in the fuel tank 10. Note that, in the following description, the vehicle transverse direction left side portion of the fuel tank 10 is called a first tank chamber 10D, and the vehicle transverse direction right side portion of the fuel tank 10 is called a second tank chamber 10E. Further, as shown in FIG. 3 and FIG. 4 as well, the fuel tank 10 has, at the inner side thereof, plural “supporting pillar portions 20” and a fuel pump module 22. Note that, in FIG. 4, members and equipment that are disposed at the periphery of the supporting pillar portion 20 are not illustrated in order to make it easy to understand the structure of the supporting pillar portion 20.

Including those which are not illustrated, two of the supporting pillar portions 20 are disposed in each of the first tank chamber 10D and the second tank chamber 10E, such that a total of four of the supporting pillar portions 20 are provided. One of the supporting pillar portions 20 that is disposed in the first tank chamber 10D is disposed at the vehicle front and outer side portion of the first tank chamber 10D, and the other of these supporting pillar portions 20 is disposed at a position that is at the vehicle rear and inner side with respect to the one supporting pillar portion 20.

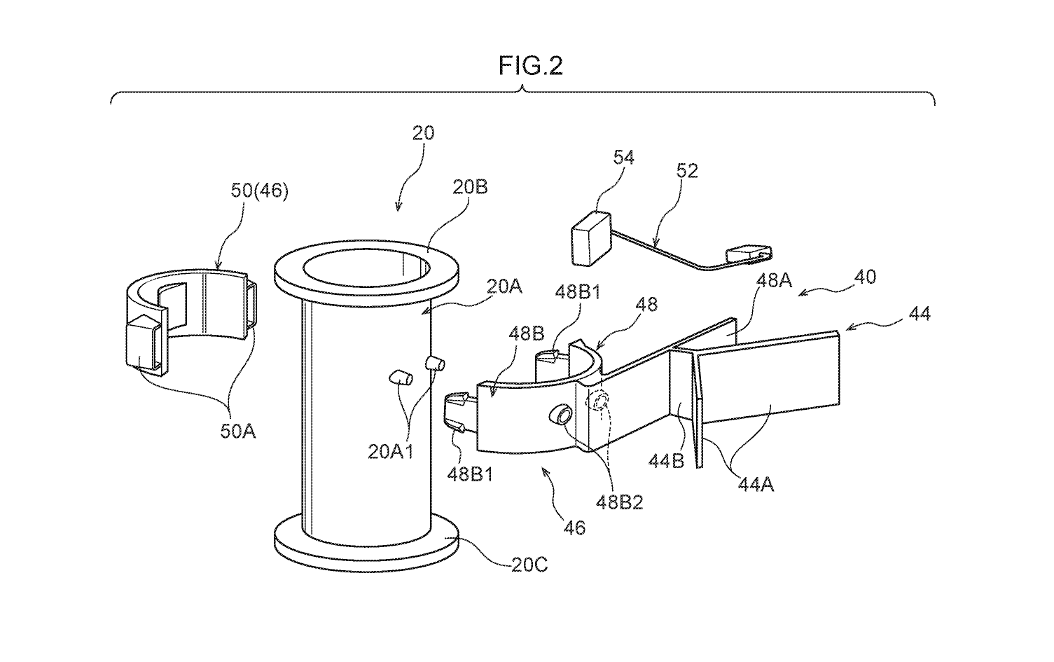

In further detail, as shown in FIG. 2 as well, the supporting pillar portion 20 is structured of the same material as the fuel tank 10, i.e., a high-density polypropylene resin, and so as to include a main body portion 20A that structures the main portion thereof, an “upper side flange portion 20B” and a “lower side flange portion 20C”.

The main body portion 20A is formed in the shape of a cylindrical tube that extends in the vehicle vertical direction, and the upper side flange portion 20B is provided at the vehicle upper side end portion thereof, and the lower side flange portion 20C is provided at the vehicle lower side end portion thereof. Namely, the upper side flange portion 20B can be considered to be one end portion of the supporting pillar portion 20, and the lower side flange portion 20C can be considered to be the other end portion of the supporting pillar portion 20.

The upper side flange portion 20B and the lower side flange portion 20C are formed integrally with the main body portion 20A, and are shaped as discs whose central portions are cut-out in circular forms as viewed from the vehicle upper side. Further, the supporting pillar portion 20 connects the upper wall portion 10A and the lower wall portion 10B in the vehicle vertical direction due to the upper side flange portion 20B being welded to the upper wall portion 10A of the fuel tank 10 and the lower side flange portion 20C being welded to the lower wall portion 10B of the fuel tank 10.

Note that plural, unillustrated pass-through portions are formed in the main body portion 20A of the supporting pillar portion 20, such that fuel can enter into the inner side of the supporting pillar portion 20.

On the other hand, as shown in FIG. 3, the fuel pump module 22 is disposed in the first tank chamber 10D, and is structured to include a “sub-cup 24”, an unillustrated fuel pump, and a jet pump that also is not illustrated. Note that, in FIG. 3, members and equipment that are disposed at the periphery of the fuel pump module 22 are not shown in order to make it easy to understand the structure of the fuel pump module 22.

The sub-cup 24 is structured of a resin material, and is shaped as a cylindrical tube that has a bottom and whose vehicle upper side is open. Some fuel can be accommodated at the inner side of the sub-cap 24. The sub-cup 24 can be inserted into the inner side of the fuel tank 10 from a pass-through portion 26 that is formed in the upper wall portion 10A of the fuel tank 10. Further, as shown in FIG. 1, the sub-cup 24 is disposed at a position that, as viewed from the vehicle vertical direction, is interposed between the two supporting pillar portions 20 that are disposed in the first tank chamber 10D. In other words, as viewed from the vehicle vertical direction, the two supporting pillar portions 20 that are disposed at the vehicle transverse direction left side are disposed at positions that are such that the sub-cup 24 is interposed therebetween. Further, the fuel pump and the jet pump are disposed at the inner side of the sub-cup 24. Note that an unillustrated flow-in port is provided at the sub-cup 24, and the sub-cup 24 and the fuel tank 10 communicate via this flow-in port.

An unillustrated fuel suction port, through which fuel can be sucked, is provided at the vehicle lower side portion of the fuel pump. Fuel that is within the sub-cup 24 can be sucked from the fuel suction port due to the fuel pump being driven. Further, the fuel that is sucked by the fuel pump is fed-out from the interior of the sub-cup 24 via an unillustrated fuel feed pipe toward the power unit.

As shown in FIG. 5, the jet pump is connected to the second tank chamber 10E via a fuel transfer pipe 28. In further detail, one end portion 28A of the fuel transfer pipe 28 is connected to a suction port portion 32 that is provided at a bracket 30 that is mounted to the supporting pillar portion 20 that is in the second tank chamber 10E. Note that the suction port portion 32 is disposed adjacent to the lower wall portion 10B of the fuel tank 10. On the other hand, the unillustrated other end portion of the fuel transfer pipe 28 is connected to the jet pump.

Further, some of the fuel that is fed-out by the fuel pump is introduced into the jet pump. Fuel that is within the second tank chamber 10E is sucked by utilizing the negative pressure that arises at the interior of the jet pump due to this fuel being introduced-in. Further, the fuel, which is sucked from the second tank chamber 10E by the jet pump, is fed into the sub-cup 24 via a transfer pipe.

Returning to FIG. 3, the pass-through portion 26 of the above-described fuel tank 10 is closed-off from the outer side of the fuel tank 10 by a cap member 34 that is disc-shaped. A pair of guide rods 36 that are solid cylindrical extend-out toward the vehicle lower side from this cap member 34. On the other hand, a pair of guiding tube portions 24A that correspond to the guide rods 36 are provided at the sub-cup 24, and the guide rods 36 can be inserted into these guiding tube portions 24A. In the state in which the cap member 34 is mounted to the fuel tank 10, the guide rods 36 are in states of being inserted in the guiding tube portions 24A.

A “coil spring 38” that serves as an urging portion is attached to each of the guide rods 36. In the state in which the cap member 34 is mounted to the fuel tank 10, these coil springs 38 are interposed between the cap member 34 and the sub-cap 24, and urge the guiding tube portions 24A, and accordingly, the sub-cup 24, from the cap member 34 side toward the lower wall portion 10B side of the fuel tank 10.

Here, as shown in FIG. 1, the present embodiment has features in the points that a “restricting portion 40” serving as a first restricting portion and a “restricting portion 42” serving as a second restricting portion are provided at the inner side of the fuel tank 10, and that relative displacement of the sub-cup 24 with respect to the fuel tank 10 can be restricted by the restricting portions 40, 42. The structures of the restricting portions 40, 42, which structure main portions of the present embodiment, are described in detail hereinafter.

The restricting portion 40 is provided at, of the two supporting pillar portions 20 that are disposed in the first tank chamber 10D, the one supporting pillar portion 20 that is disposed at the vehicle front and outer side. This supporting pillar portion 20 functions as a first supporting pillar portion. On the other hand, the restricting portion 42 is provided at the other supporting pillar portion 20 among the two supporting pillar portions 20 that are disposed in the first tank chamber 10D, and this supporting pillar portion 20 functions as a second supporting pillar portion. Note that the restricting portions 40, 42 are formed of a high-density polyethylene resin.

As shown in FIG. 2 as well, the restricting portion 40 is a structure that can be mounted to the supporting pillar portion 20, i.e., is a body separate from the supporting pillar portion 20, and is structured to include an “abutting portion 44” and a “supporting portion 46” that supports the abutting portion 44. In further detail, the abutting portion 44 is structured to include a pair of “abutting piece portions 44A” that serve as first abutting piece portions, and an extension piece portion 44B.

The abutting piece portions 44A are shaped as plates that are rectangular and that extend in the vehicle transverse direction, as viewed from the axis of the sub-cup 24. The abutting piece portions 44A are disposed so as to form a V-shape that is convex toward the vehicle front side, as viewed from the vehicle vertical direction. Further, the pair of abutting piece portions 44A are disposed adjacent to the sub-cup 24 so as to overlap a portion of or the entirety of the sub-cup 24 as seen both from the vehicle longitudinal direction and from the vehicle transverse direction. On the other hand, the extension piece portion 44B extends-out toward the vehicle front side from the border portion between the abutting piece portions 44A, and is shaped as a plate whose plate-thickness direction is the vehicle transverse direction, and connects the abutting piece portions 44A and the supporting portion 46.

The supporting portion 46 has a first supporting portion 48, which is structured to include a supporting plate portion 48A that is integral with the abutting portion 44 and a semi-cylindrical portion 48B that is provided integrally with the supporting plate portion 48A, and a second supporting portion 50 that is formed as a body separate from the first supporting portion 48.

The supporting plate portion 48A of the first supporting portion 48 is connected to the vehicle front side end portion of the extension piece portion 44B of the abutting portion 44. The supporting plate portion 48A is formed in the shape of a plate that is rectangular and whose plate-thickness direction is the vehicle longitudinal direction and that, as viewed from the vehicle longitudinal direction, extends from the extension piece portion 44B toward the vehicle transverse direction outer side and the vehicle transverse direction inner side.

Further, an unillustrated mounted-to portion, to which a mounting portion 54 of a “fuel gauge 52” can be mounted, is provided at the vehicle front side surface of the vehicle transverse direction inner side end portion of the supporting plate portion 48A. The fuel gauge 52 is mounted to the supporting portion 46 due to the mounting portion 54 being mounted to this mounted-to portion. Note that the fuel gauge 52 is mounted also to the bracket 30 that is mounted to the supporting pillar portion 20 that is in the second tank chamber 10E. Further, the semi-cylindrical portion 48B is provided at the vehicle transverse direction outer side end portion of the supporting plate portion 48A.

As viewed from the vehicle vertical direction, the semi-cylindrical portion 48B is shaped as an arc that is convex toward the vehicle rear side, and is shaped as a semi-cylinder of a size that is sufficient to cover the outer periphery of the main body portion 20A of the supporting pillar portion 20 from the vehicle rear side. The dimension of the semi-cylindrical portion 48B in the vehicle vertical direction is set to a dimension that is about the same as the dimension of the supporting plate portion 48A in the vehicle vertical direction.

Anchor portions 48B1 are provided at the end portions that are at the vehicle transverse direction both sides of the semi-cylindrical portion 48B, respectively. These anchor portions 48B1 are used in connecting the semi-cylindrical portion 48B and the second supporting portion 50 as will be described later. Further, a pair of fit-into portions 48B2 that are disposed so as to be apart from one another in the vehicle transverse direction are provided at the length direction central portion of the semi-cylindrical portion 48B. These fit-into portions 48B2 are formed in the shapes of cylinders whose axial directions are the vehicle longitudinal direction. On the other hand, a pair of fitting portions 20A1 that are shaped as solid cylinders and correspond to the fit-into portions 48B2 are provided at the main body portion 20A of the supporting pillar portion 20. The first supporting portion 48 is mounted to the supporting pillar portion 20 due to the fitting portions 20A1 being fit-together with the fit-into portions 48B2.

As viewed from the vehicle vertical direction, the second supporting portion 50 is shaped as a circular arc that is convex toward the vehicle front side, and is shaped as a semi-cylinder of a size that is sufficient to cover the outer periphery of the main body portion 20A of the supporting pillar portion 20 from the vehicle front side. The dimension of the second supporting portion 50 in the vehicle vertical direction is set to a dimension that is about the same as the dimension of the supporting plate portion 48A in the vehicle vertical direction. Namely, the second supporting portion 50 is a structure that is basically symmetrical to the structure of the semi-cylindrical portion 48B of the first supporting portion 48 across the axis of the main body portion 20A of the supporting pillar portion 20.

Anchored-to portions 50A that correspond respectively to the anchor portions 48B1 of the first supporting portion 48 are provided at the end portions at the vehicle transverse direction both sides of the second supporting portion 50. Due to the anchor portions 48B1 being anchored on the anchored-to portions 50A, the semi-cylindrical portion 48B of the first supporting portion 48 and the second supporting portion 50 are connected, and the semi-cylindrical portion 48B and the second supporting portion 50 form a cylindrical tube shape that runs along the outer peripheral surface of the main body portion 20A of the supporting pillar portion 20.

Returning to FIG. 1, the restricting portion 42 is structured basically similarly to the restricting portion 40, and, as viewed from the vehicle vertical direction, is disposed so as to be symmetrical to the restricting portion 40 across the axis of the sub-cup 24. In detail, the restricting portion 42 is structured to include an “abutting portion 56” and a “supporting portion 58”. The abutting portion 56 is structured to include a pair of “abutting piece portions 56A” that serve as second abutting piece portions, and an extension piece portion 56B. On the other hand, in the same way as the supporting portion 46, the supporting portion 58 has a first supporting portion 60, which is structured to include a supporting plate portion 60A and a semi-cylindrical portion 60B, and a second supporting portion 62 that is a body separate from the first supporting portion 60. However, the supporting portion 58 differs from the supporting portion 46 with regard to the point that the fuel gauge 52 is not mounted to the supporting portion 58.

Further, in the same way as the abutting piece portions 44A of the restricting portion 40, the abutting piece portions 56A of the restricting portion 42 also are disposed adjacent to the sub-cup 24. Therefore, even if external force is inputted to the sub-cup 24 and the sub-cup 24 is displaced relative to the fuel tank 10, this relative displacement, and in particular, relative displacement of the sub-cup 24 with respect to the fuel tank 10 in directions orthogonal to the vehicle vertical direction, can be restricted. In addition, changes in the posture of the sub-cup 24 with respect to the fuel tank 10, which are due to external force being inputted to the sub-cup 24, also can be restricted by the restricting portions 40, 42.

### Operation and Effects of Present Embodiment

Operation and effects of the present embodiment are described next.

The present embodiment has the fuel tank 10 that is made of resin and that can store fuel that is to be supplied to the power unit that is mounted in the vehicle 12. This fuel tank 10 is structured to include the upper wall portion 10A that structures the vehicle upper side portion thereof, and the lower wall portion 10B that structures the vehicle lower side portion thereof. Further, the supporting pillar portions 20 that are made of resin are provided at the inner side of the fuel tank 10. The upper side flange portions 20B of the supporting pillar portions 20 are welded to the upper wall portion 10A of the fuel tank 10, and the lower side flange portions 20C of the supporting pillar portions 20 are welded to the lower wall portion 10B of the fuel tank 10. The upper wall portion 10A and the lower wall portion 10B are connected by the supporting pillar portions 20 in the vehicle vertical direction. Therefore, in the present embodiment, relative displacement of the upper wall portion 10A and the lower wall portion 10B of the fuel tank 10 is suppressed, and accordingly, the shape of the fuel tank 10 can be maintained in a stable state.

Moreover, in the present embodiment, the sub-cup 24 is disposed at the inner side of the fuel tank 10, and the sub-cup 24 can store some of the fuel that is stored in the fuel tank 10. Therefore, even if the fuel tank 10 tilts and there becomes a state in which the fuel that is stored at the inner side of the fuel tank 10 is unevenly distributed, fuel can be supplied stably to the power unit by using the fuel that is stored in the sub-cup 24.

In addition, the present embodiment is provided with the coil springs 38 that urge the sub-cup 24 toward the lower wall portion 10B side of the fuel tank 10. The sub-cup is urged by the coil springs 38 and is pushed against the lower wall portion 10B. Therefore, relative displacement of the sub-cup 24 and the lower wall portion 10B is suppressed by the frictional force that arises between the sub-cup 24 and the lower wall portion 10B of the fuel tank 10, and changes in the posture of the sub-cup 24 can be suppressed.

By the way, when the fuel within the fuel tank 10 moves at the time of acceleration or deceleration of the vehicle or the like, the sub-cup 24 receives force from the fuel that moves, and it is thought that the position and/or the posture of the sub-cup 24 with respect to the fuel tank 10 will change.

Here, in the present embodiment, the restricting portion 40 is provided at the one supporting pillar portion 20 of the two supporting pillar portions 20 that are disposed in the sub-cup 24 side of the fuel tank 10, and the restricting portion 42 is provided at the other supporting pillar portion 20. Further, relative displacement, in directions orthogonal to the vehicle vertical direction, of the sub-cap 24 with respect to the fuel tank can be restricted by the restricting portions 40, 42. Therefore, at times of acceleration and deceleration of the vehicle 12 or the like, even if the sub-cup 24 is displaced relative to the fuel tank 10 in a direction orthogonal to the vehicle vertical direction due to fuel within the fuel tank 10 moving and the sub-cup 24 receiving force from the fuel, this relative displacement is restricted by the restricting portions 40, 42. Accordingly, in the present embodiment, the position and the posture of the sub-cup 24 with respect to the fuel tank 10 can be kept in stable states.

Further, the present embodiment has the one supporting pillar portion 20 at which the restricting portion 40 is provided, and the other supporting pillar portion 20 at which the restricting portion 42 is provided. These supporting pillar portions 20 are disposed at positions that are such that the sub-cup 24 is interposed therebetween, as viewed from the vehicle vertical direction. Therefore, in the present embodiment, relative displacement of the sub-cup 24 with respect to the fuel tank 10 in directions orthogonal to the vehicle vertical direction can be restricted from two directions as viewed from the vehicle vertical direction. Accordingly, in the present embodiment, the accuracy of restricting relative displacement of the sub-cup 24 with respect to the fuel tank 10 in directions orthogonal to the vehicle vertical direction can be improved.

Further, in the present embodiment, the restricting portions 40, 42 are structured by bodies that are separate from the supporting pillar portions 20 of the fuel tank 10. The restricting portion 40 is structured to include the abutting portion 44 and the supporting portion 46, and the restricting portion 42 is structured to include the abutting portion 56 and the supporting portion 58. Further, relative displacement of the sub-cup 24 with respect to the fuel tank 10 in directions orthogonal to the vehicle vertical direction is restricted due to the abutting portions 44, 56 abutting the sub-cup 24. On the other hand, the supporting portion 46 supports the abutting portion 44 and is mounted to the supporting pillar portion 20, and the supporting portion 58 supports the abutting portion 56 and is mounted to the supporting pillar portion 20. Therefore, in the present embodiment, as compared with a structure in which the restricting portions 40, 42 are provided integrally with the supporting pillar portions 20, the positions of the portions, which restrict displacement of the sub-cup, at the restricting portions 40, 42, i.e., the positions of the abutting portions 44, 56, can be set easily.

By the way, in a case in which the restricting portion 40, 42 and the supporting pillar portion 20 are made integral and are structured by a single member, if the positional relationship between the supporting pillar portion 20 and the sub-cup 24 is to be changed due to a change in the shape of the fuel tank 10 corresponding to the type of vehicle, or the like, the shapes of these members must be changed as well in order to correspond to that positional relationship. Namely, in a structure in which the restricting portion 40, 42 and the supporting pillar portion are made to be an integral member, common usage of these members at the fuel tanks 10 of different shapes cannot be devised.

On the other hand, in the present embodiment, even if the positional relationship between the supporting pillar portion 20 and the sub-cup 24 is to be changed due to a change in the shape of the fuel tank 10 that corresponds to the type of the vehicle, or the like, correspondence with that positional relationship can be achieved by changing the shape of either one of the supporting pillar portion 20 and the restricting portion 40, 42. Therefore, the shape of the other of the supporting pillar portion 20 and the restricting portion 40, 42 can be maintained. As a result, the supporting pillar portion 20 or the restraining portion 40, 42 can be used in common at the fuel tanks 10 that have different shapes, while the positioning of the restricting portion 40, 42 and the sub-cup 24 is simplified.

Further, in the present embodiment, the restricting portion 40 has the pair of abutting piece portions 44A, and the restricting portion 42 has the pair of abutting piece portions 56A. Therefore, in the present embodiment, relative displacement of the sub-cup 24 with respect to the fuel tank 10 in directions orthogonal to the vehicle vertical direction can be supported at two places at the restricting portion 40 and can be supported at two places at the restricting portion 42. Further, when the sub-cup 24 is inserted into the inner side of the fuel tank 10, the abutting piece portions 44A, 56A can be used as guides, and positioning of the sub-cup 24 is easy. Accordingly, in the present embodiment, relative displacement of the sub-cup 24 with respect to the fuel tank 10 in directions orthogonal to the vehicle vertical direction can be restricted to a stable state, and the work of mounting the sub-cup 24 to the fuel tank 10 can be made to be easy.

In addition, in the present embodiment, the fuel gauge 52 can be mounted to the supporting portion 46 which structures a portion of the restricting portion 40. As compared with a case in which a member for mounting the fuel gauge 52 is provided separately, the number of parts that are disposed within the fuel tank 10 can be reduced. Accordingly, in the present embodiment, the structure of the interior of the fuel tank 10 can be simplified while the volume of the fuel tank 10 is ensured.

### Second Embodiment

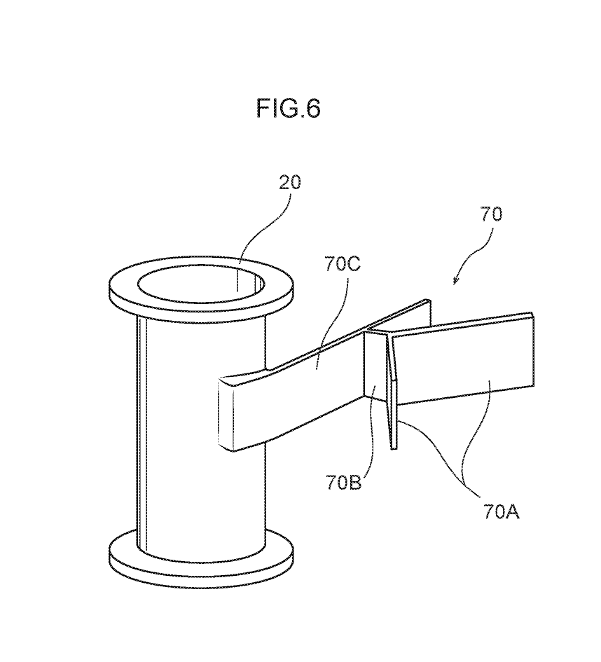

A second embodiment of the fuel tank structure relating to the present disclosure is described hereinafter by using FIG. 6. Note that structural portions that are the same as those of the above-described first embodiment are denoted by the same reference numerals, and description thereof is omitted.

The fuel tank structure relating to the present embodiment has features in the points that the supporting pillar portion 20 and a “restricting portion 70” that corresponds to the restricting portion 40 are made integral, and that the supporting pillar portion 20 and an unillustrated restricting portion that corresponds to the restricting portion 42 are made integral.

Concretely, the restricting portion 70 is structured to include a pair of “abutting piece portions 70A” that serve as first abutting piece portions and correspond to the abutting piece portions 44A, an extension piece portion 70B that corresponds to the extension piece portion 44B, and a supporting plate portion 70C that corresponds to the supporting plate portion 48A. Further, the restricting portion 70 is in a state of being connected to the main body portion 20A of the supporting pillar portion 20 at the vehicle transverse direction outer side end portion of the supporting plate portion 70C. Note that the restricting portion that corresponds to the restricting portion 42 has a structure that is similar to that of the restricting portion 70.

In accordance with such a structure, operation and effects that are similar to those of the above-described first embodiment are obtained, except for the operation and effects that are due to the restricting portions 40, 42 being provided as bodies separate from the supporting pillar portions 20. Further, in the present embodiment, by structuring the restricting portion 70 and the supporting pillar portion 20 integrally, the number of parts within the fuel tank 10 can be reduced, and the structure of the interior of the fuel tank 10 can be simplified.

### Supplementary Description of Above Embodiments

(1) The above-described embodiments are structured such that the pair of abutting piece portions are provided at the restricting portion, but the present disclosure is not limited to this. For example, there may be a structure in which one abutting piece portion which extends uniformly in the vehicle transverse direction or the vehicle longitudinal direction is provided at the restricting portion. Further, although the restricting portions are provided at the plural supporting pillar portions 20 in the above-described embodiments, there may be a structure in which a restricting portion is provided at one of the supporting pillar portions 20. Note that, in this case, the restricting portion may be made to be the shape of a tube that extends in the vehicle vertical direction.

(2) Further, the above-described embodiments are structured such that the sub-cup 24 is disposed within the first tank chamber 10D of the fuel tank 10, and the restricting portions are provided at the supporting pillar portions 20 of the first tank chamber 10D. However, the present disclosure is not limited to this. For example, there may be a structure in which the sub-cup 24 is disposed in the second tank chamber 10E of the fuel tank 10, and the restricting portions are provided at the supporting pillar portions 20 of the second tank chamber 10E. Note that, in this case, there may be a structure in which the fuel gauge 52 and/or the suction port portion 32 are mounted to the restricting portion.

(3) Moreover, in the above-described embodiments, the fuel tank structures relating to the respective embodiments are applied to the fuel tank 10 that is a saddle-type tank, but the present disclosure is not limited to this. The fuel tank structures relating to the respective embodiments may be applied to fuel tanks of types other than a saddle type, provided that the fuel tank is made of resin and has a supporting pillar portion.

(4) In addition, in the above-described embodiments, the fuel tank 10, the supporting pillar portions 20 and the restricting portions are made of high-density polyethylene resin, but the fuel tank 10, the supporting pillar portions 20 and the restricting portions may be formed of resin other than this in accordance with the specifications.

What is claimed is:

1. A fuel tank structure comprising:
a fuel tank that is made of resin, that is structured to include an upper wall portion that structures a vehicle upper side portion and a lower wall portion that structures a vehicle lower side portion, and that stores fuel that is to be supplied to a power unit mounted in a vehicle;
a supporting pillar portion that is made of resin, that is provided at an inner side of the fuel tank, that has one end portion welded to the upper wall portion and another end portion welded to the lower wall portion, and that connects the upper wall portion and the lower wall portion in a vehicle vertical direction;
a sub-cup that is disposed at the inner side of the fuel tank, and that stores some of the fuel;
an urging portion that urges the sub-cup toward the lower wall portion; and
a restricting portion that is provided at the supporting pillar portion, and that restricts relative displacement of the sub-cup with respect to the fuel tank in directions orthogonal to the vehicle vertical direction.

2. The fuel tank structure of claim 1, wherein:
a first supporting pillar portion, which serves as the supporting pillar portion and at which a first restricting portion that serves as the restricting portion is provided, and a second supporting pillar portion, which serves as the supporting pillar portion and at which a second restricting portion that serves as the restricting portion is provided, are provided at the fuel tank; and
the first supporting pillar portion and the second supporting pillar portion are disposed at positions such that the sub-cup is interposed therebetween as viewed from the vehicle vertical direction.

3. The fuel tank structure of claim 1, wherein:
the restricting portion is structured by a body that is separate from the supporting pillar portion; and
the restricting portion is structured to include an abutting portion, which restricts the relative displacement by abutting the sub-cup, and a supporting portion, which supports the abutting portion and is mounted to the supporting pillar portion.

4. The fuel tank structure of claim 2, wherein:
the restricting portion is structured by a body that is separate from the supporting pillar portion; and
the restricting portion is structured to include an abutting portion, which restricts the relative displacement by abutting the sub-cup, and a supporting portion, which supports the abutting portion and is mounted to the supporting pillar portion.

5. The fuel tank structure of claim 4, wherein:
the first restricting portion has a pair of first abutting piece portions that serve as the abutting portion; and
the second restricting portion has a pair of second abutting piece portions that serve as the abutting portion.

6. The fuel tank structure of claim 3, wherein a fuel gauge is mounted to the supporting portion.

7. The fuel tank structure of claim 4, wherein a fuel gauge is mounted to the supporting portion.

8. The fuel tank structure of claim 5, wherein a fuel gauge is mounted to the supporting portion.
